(19) United States
(12) Patent Application Publication
(10) Pub. No.: US 2010/0029250 A1
(43) Pub. Date: Feb. 4, 2010

(54) SYSTEM AND METHOD FOR ROUTING MESSAGES TO COMMUNICATION DEVICES ASSOCIATED WITH A USER

(75) Inventor: SHEKHAR GUPTA, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/181,922

(22) Filed: Jul. 29, 2008

(51) Int. Cl. H04M 3/42; H04M 11/10; H04Q 7/20

(52) U.S. Cl. 455/413; 455/417; 455/466; 455/415

(57) ABSTRACT

An embodiment of a method for message routing includes receiving a message addressed to a user of a first user communication device, and determining whether the user has accessed the message within a predetermined time period. The method further includes routing the message to a second user communication device associated with the user if the user has not accessed the message within the predetermined time period. Some embodiments further include converting the message from a first format into a second format before routing the message to the second user communication device. Some embodiments further include determining a caller identity associated with the calling device, determining a routing policy associated with the caller identity, and determining the second user communication device from among a plurality of user communication devices based upon the routing policy.

### BACKGROUND

Users often have access to a number of communication devices for which they can receive calls and messages from callers. At particular time and day a user may not have immediate access to a particular communication device when a caller places a call to that particular communication device. Sometimes, the caller will be prompted to leave a voicemail for the user. However, the user may not be aware of that a voicemail or other message has been sent until much later after the voicemail or other message has been left. In the event that voicemail or message is urgent, the user will often not access the voicemail or message until it is too late.

### SUMMARY

An embodiment of a method for message routing includes receiving a message addressed to a user of a first user communication device, and determining whether the user has accessed the message within a predetermined time period. The method further includes routing the message to a second user communication device associated with the user if the user has not accessed the message within the predetermined time period. Some embodiments further include converting the message from a first format into a second format before routing the message to the second user communication device. Some embodiments further include determining a caller identity associated with the calling device, determining a routing policy associated with the caller identity, and determining the second user communication device from among a plurality of user communication devices based upon the routing policy.

Another embodiment of a method for message routing includes receiving a message addressed to a user of a first user communication device, and determining whether the user has accessed the message within a user-defined time period. The method further includes sending a notification message to a second user communication device associated with the user if the user has not accessed the message within the user-defined time period. The notification message indicates that a message has been left by a caller at the first user communication device. In some embodiments the notification message includes an identification of the caller, and/or a time that the message was received at the first user communication device.

Another embodiment of a method for message routing includes receiving a missed call at a first user communication device associated with a user, and sending a notification message to a second user communication device associated with the user. The notification message indicates to the user that a call from a caller has been missed at the first user communication device. In some embodiments, the notification message includes an identification of the caller, and/or a time that the call was missed at the first user communication device.

### BRIEF DESCRIPTION OF THE DRAWINGS

Illustrative embodiments of the present invention are described in detail below with reference to the attached drawing figures, which are incorporated by reference herein and wherein:

FIG. 1 is an embodiment of a system for routing messages to user communication devices;

FIG. 2 is an embodiment of a procedure for configuring a personal profile for routing messages to one or more user communication devices associated with a user;

FIG. 3 is an embodiment of a procedure for routing voicemail messages to one or more communication devices associated with a user; and

FIG. 4 is an embodiment of a procedure for routing text messages to one or more communication devices associated with the user;

FIG. 5 is an embodiment of procedure for configuring notification message delay for one or more user communication devices associated with a user;

FIG. 6 is a procedure for sending a notification message indicating that message has been received at a user communication device after a user-defined time period has elapsed; and

FIG. 7 is an embodiment of a procedure for sending a notification message of a missed call at a user communication device.

### DETAILED DESCRIPTION

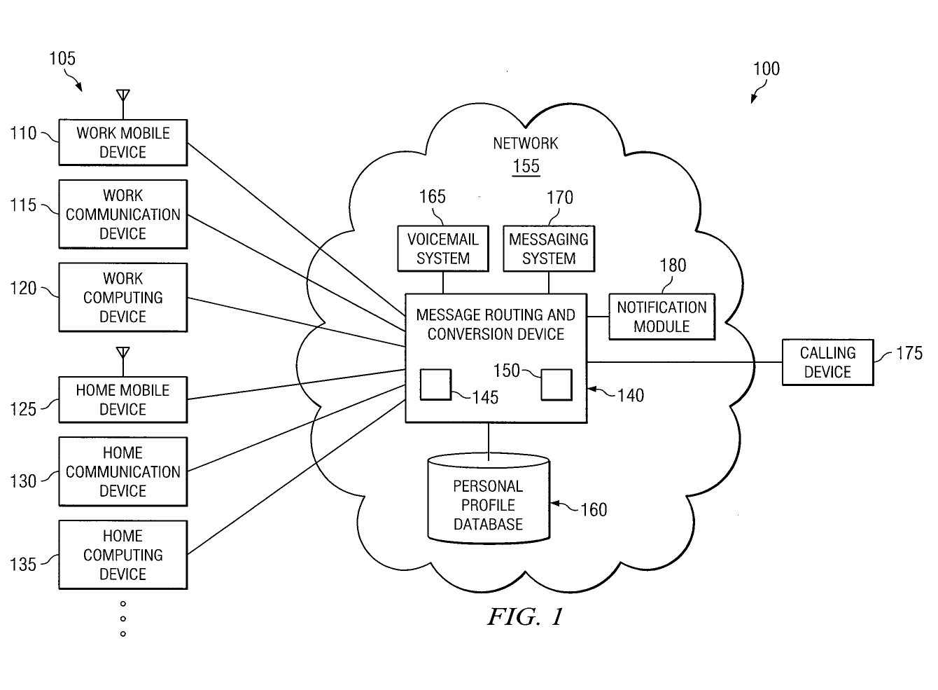

FIG. 1 is an embodiment of system 100 for routing messages to communication devices associated with a user. The system 100 includes a number of different user communication devices 105. In the embodiment illustrated in FIG. 1, the user communication devices 105 include a work mobile device 110, a work communication device 115, a work computing device 120, a home mobile device 125, a home communication device 130, and a home computing device 135. Each of the user communication devices 105 is associated with a particular user. In at least one embodiment, the work mobile device 110 is a mobile handset associated with the user's work. In an example embodiment, the work communication device 115 is a telephone located at the user's workplace that supports voice communication and voicemail. In at least one embodiment, the work computing device 120 is a personal computer located at the user's workplace that supports instant messaging and email. The home mobile device 125 is a personal mobile handset associated with the user that supports voice communication, voicemail, and text messaging. In at least one embodiment, the home communication device 130 is a telephone located at the user's home that supports voice communication and voicemail. In at least one embodiment, the home computing device 135 is a personal computer located at the user's home that supports instant messaging and email.

The system 100 further includes a message routing and conversion device 140. The message routing and conversion device 140 further includes a processor 145 and a memory 150. The memory 150 includes computer instructions configured to cause the processor 145 to perform the various functions of the message routing and conversion device 140 described herein. In the illustrated embodiment, the message routing and conversion device 140 is located in a network 155 and is in communication with each of the user communication devices 105 via the network 155. The message routing and conversion device 140 is in further communication with a personal profile database 160. In at least one embodiment, the message routing and conversion device 140 is configured to route to one or more of the user communication devices 105 according to user profile information contained in a personal profile stored in the personal profile database 160. In at least one embodiment, the message routing and conversion device 140—is further configured to convert messages into a desired format before routing the messages to one or more of the user communication devices 105. In various embodiments, the personal profile database 160 is further configured to store user profile information associated with a number of different users and/or subscribers.

The message routing and conversion device 140 is in further communication with a voicemail system 165 and a messaging system 170. The voicemail system 165 is configured to record one or more voicemails intended for the user of the user communication devices 105, as well as route recorded voicemails to the appropriate user communication devices 105. The messaging system 170 is configured to process the sending of messages, such as text messages, to the user communication devices 105. In at least one embodiment, the messages are Short Messaging Service (SMS) messages. In still another embodiment, the text messages are instant messaging (IM) messages.

The system 100 illustrated in FIG. 1 further includes a calling device 175. The calling device 175 is configured to allow a caller to place voice calls to one or more of the user communication devices 105. In at least one embodiment, the message routing and conversion device 140 routes messages and voicemails to one or more of the user communication devices 105 associated with the user based on the user profile information stored in the personal profile database 160. In at least one embodiment, the user profile information stored in the personal profile database 160 includes time-of-day routing information, as well as other information related to routing features, such as call forwarding, call rejection, simultaneous message delivery to multiple user communication devices 105, and sequential delivery of messages to one or more of the user communication devices 105. The time-of-day routing information includes information indicating the user's expected location at a particular time-of-day and a particular day of the week or date. Examples of time-of-day routing information include public holidays, scheduled vacations, working hours, nonworking hours, and other user location information. Examples of user location information include whether the user is at home, work, away from office, or working remotely. In at least one embodiment, the user profile information may be configured and/or modified by the user. In at least one embodiment, the user may configure and/or modify the user profile information using a web portal located on the Internet or company intranet.

The user profile information may further include information related to the manner in which a call and/or message from a particular calling party is to be routed or otherwise handled. For example, the user may set up a personal VIP list such that calls from a particular caller on the personal VIP list are routed to particular user communication devices. Similarly, the user may set up a work list, a work VIP list, a home list, and other specialty lists related to particular callers. The user profile may further include destination information related to where a particular message from a particular caller is to be routed. Examples of destination information include the work mobile device 110, the work communication device 115, the work computing device 120, the home mobile device 125, the home communication device 130, and the home computing device 135. For example, the user may place his boss on a work VIP list so that if the boss calls him at his work communication device 115, the call is quickly routed to the user's home mobile device 125. In at least one embodiment, the user profile information may further include message format information associated with each user communication device 105. The message format information includes one or more desired formats in which the user wishes to receive messages sent to each of the user communication device 105. The system 100 further includes a notification module 180 configured to send notification messages to one or more of the user communication devices 105 indicating that a voicemail has been left or that a missed call has occurred at one or more of the user communication devices.

In an example operation of the embodiment of FIG. 1, a caller using calling device 175 places a call to the work communication device 115 associated with the user. If the user does not answer the call, the caller records a voicemail for the user using the voicemail system 165. If the user has not listened to the voicemail within a predetermined time period, for example, ten minutes, the message routing and conversion device 140 forwards the voicemail and/or converts the voicemail into a text message and sends the text message to the work mobile device 110 in accordance with the information contained in the user's personal profile. Alternatively, rather than sending the actual voice message or text conversion thereof, a voicemail notification message (e.g., email or may be communicated to the work mobile device 110. In one embodiment, the notification message may immediately be sent. Alternatively, the notification message may be sent after a time delay set by the user or caller who left the message as prompted by the voicemail system. In the presently described example, the message routing and conversion device 140 converts the voicemail into a text message before sending the text message to the work mobile device 110. If the user does not view the text message within a predetermined time period using the work mobile device 110, the message routing conversion device 140 forwards the text message to the work computing device 120. In at least one embodiment the message routing and conversion device 140 forwards the text message to the work computing device 120 as an instant message (IM). In still other embodiments the message routing and conversion device 140 forwards the text message to the work computing device 120 as an email. If the user still has not viewed the text message using the work computing device within a predetermined time period, the message routing and conversion device 140 will sequentially forward the message to other user communication devices 105 in accordance with the personal profile information. For example, the message routing and conversion device 140 may sequentially and/or simultaneously forward the message to the home mobile device 125, the home communication device 130, and the home computing device 135 in either a text or audio/voice format.

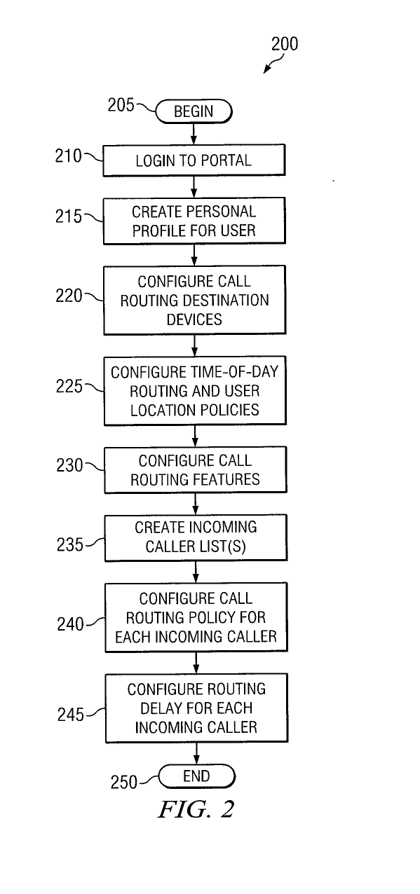

FIG. 2 is an embodiment of a procedure 200 for configuring a personal profile for routing messages to one or more user communication devices associated with a user. The procedure 200 begins in step 205. In step 210, the user logs in to a portal by entering a user ID and/or password. In at least one embodiment, the portal is a web portal. In step 215 the user creates a personal profile. In step 220 the user configures call routing destination devices for the personal profile. In an example embodiment associated with the user, the user configures phone numbers and/or addresses associated with each of the work mobile device 110, the work communication device 115, the work computing device 120, the home mobile device 125, the home communication device 130, and home computing device 135. In step 225, the user configures time-of-day routing and user location policies associated with the personal profile. The time-of-day routing and user location policies include information, such as the expected location of the user and the particular user communication devices 105 that are accessible to the user at a particular time of day, a particular working status and/or particular day of the week or date. In step 230, the user configures any call routing features that are desired by the user. Examples of call routing features include simultaneous message forwarding, Find Me/Follow Me message routing, message forwarding, message rejection, and message conversion such as speech to text, text to speech, etc.

In step 235, the user creates one or more incoming caller lists. The incoming caller lists include a calling phone number and/or name associated with one or more incoming callers. In at least one embodiment, the incoming caller lists includes a personal VIP list, a work list, a work VIP list, and a home list. In step 240, the user configures call routing policies for each incoming caller in the incoming caller list. In configuring the call routing policies for each incoming caller, the user specifies the user communication devices 105 for which the user wishes to receive incoming messages from a particular caller. The call routing policies for each incoming caller may further include a priority level associated with one or more of the user communication devices 105 that indicates the order in which messages from incoming callers are to be routed to each of the user communication devices In step 245 the user configures a routing delay for each incoming caller. The routing delay specifies a predetermined time period (e.g., 30 minutes) that is to elapse before a message forwarded to a particular user communication device 105 is to be forwarded to the next priority user communication device 105 if the user has not accessed the message. In step 250, the procedure 200 ends. In various embodiments, the user profile information is contained in a personal profile stored in the personal profile database 160.

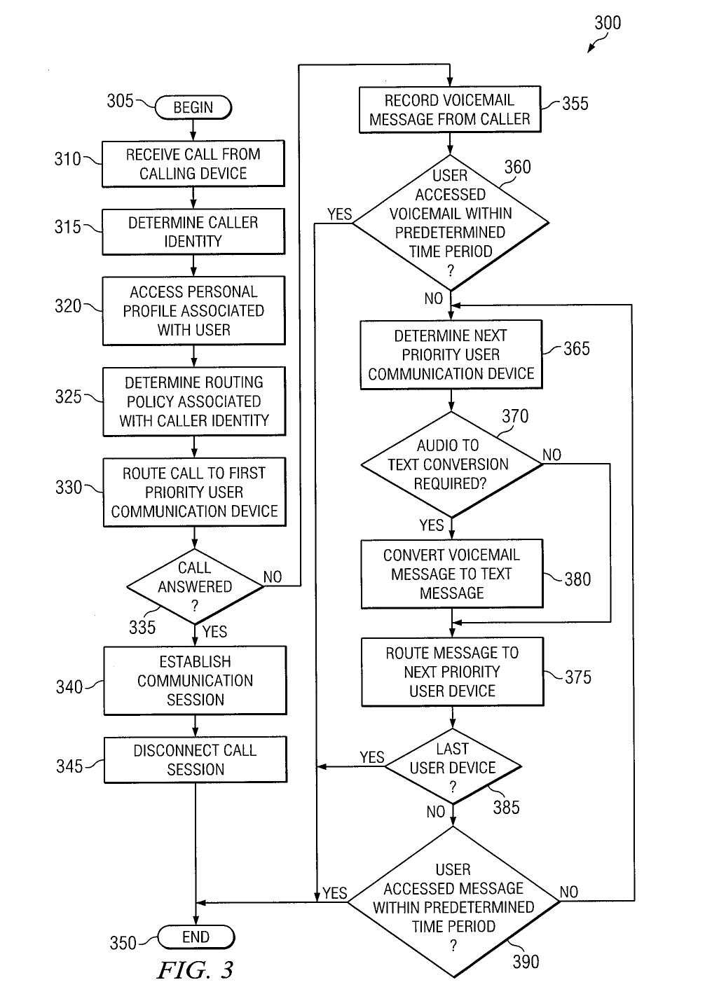

FIG. 3 is an embodiment of a procedure 300 for routing voicemail messages to one or more user communication devices associated with a particular user. The procedure 300 begins at step 305. In step 310, the message routing and conversion device 140 receives an incoming call from a caller using calling device 175 addressed to one of the user communication devices 105. In an example embodiment, the call is addressed to work communication device 115.

In step 315, a caller identity associated with the call may be determined. In at least one embodiment, the caller identity is determined using Caller ID information. In step 320, the message routing and conversion device 140 accesses the personal profile information associated with the user stored in the personal profile database 160. In step 325, the message routing conversion device 140 determines a routing policy associated with the caller identity. In at least one embodiment the routing policy includes prioritization information associated with a prioritization of user communication devices 105 associated with the caller's identity. In an example embodiment, the location status of the user is that of working in his work environment. In such an embodiment, an example of prioritization of user communication devices 105 includes the work communication device 115 having a first priority, the work mobile device 110 having a second priority, a working computing device 120 having a third priority, the home mobile device 125 having a fourth priority, the home communication device 130 having a fifth priority, and the home computing device 135 having a sixth priority. In the example embodiment, messages are forwarded to user communication devices 105 having a greater priority before user communication devices 105 having a lesser priority. For example, in the example embodiment, messages are forwarded to the work communication device 115 before they are forwarded to the work mobile device 110.

In step 330, the call is routed to a first priority user communication device 105. In an example embodiment, the first priority user communication device is the work communication device 115. In step 335, it is determined whether the call has been answered by the user. If the call was answered by the user, the procedure 300 continues to step 340 in which a communication session is established between the first priority user communication device 105 and the calling device 175. Once the established communication session has ended, the procedure continues to step 345 in which the call session is disconnected. The procedure then continues to step 350 in which the procedure 300 ends. If the call is not answered by the user in step 335, the procedure continues to step 355.

In step 355, the caller records a voicemail message addressed to the user. In step 360, it is determined whether the user has accessed the voicemail within a predetermined time period. In at least one embodiment, the predetermined time period is five minutes. In an alternative embodiment, the predetermined time period may be set to zero. In still other embodiments, the predetermined time period may be configured by the user for each user communication device 105 and/or for each incoming caller. If it is determined in step 360 that the user has accessed the voicemail within the predetermined time period, the procedure continues to step 350 in which the procedure ends. If it is determined in step 360 that the user has not accessed the voicemail within the predetermined time period, the procedure continues to step 365. In step 365, the next priority user communication device 105 is determined. In an example embodiment, the next priority user communication device 105 is the work mobile device 110.

In step 370, it is determined whether an audio to text conversion procedure is required in order to forward the voicemail message to the next priority user communication device 105. If it is determined at step 370 that no audio to text conversion is required, the procedure continues to step 375. In step 375, the voicemail message is routed to the next priority user communication device 105. If it is determined in step 370 that audio to text conversion is required, the procedure continues to step 380 in which the voicemail message is converted to a text message, in accordance with the one or more of the existing procedures for converting voice audio into text. The procedure 300 then returns to step 375 in which the converted message is routed to the next priority user communication device 105.

In step 385, it is determined whether the next priority user device 105 (determined in step 365) is the last user communication device in the user's prioritization of user communication devices 105. If in step 385 it is determined that the current priority user communication device 105 is the last user device, the procedure continues to step 350 in which the procedure ends. If it is determined in step 385 that it is not the last user communication device 105 in the prioritization of user communication devices 105, the procedure continues to step 390. In step 390, it is determined whether the user has accessed the message using the next priority user communication device 105 within a predetermined time period. In at least one embodiment, the predetermined time period may be the same as that of step 360. In still other embodiments, the predetermined time period may be configured by the user for each user communication device 105 and for each caller. Accessing of the message by the user may include, for example, listening to a voicemail and/or viewing a text message by the user. If it is determined in step 390 that the user has accessed the message using the next priority user communication device 105 within the predetermined time period, the procedure continues to step 350 in which the procedure ends. If it is determined in step 390 that the user has not accessed the message using the next priority user device 105 within the predetermined time period, the procedure returns to step 365. In step 365, the next priority user communication device 105 is determined. In various embodiments, steps 370 to 390 are performed until the message has been sent to the last priority user device 105 or the user accesses the messages.

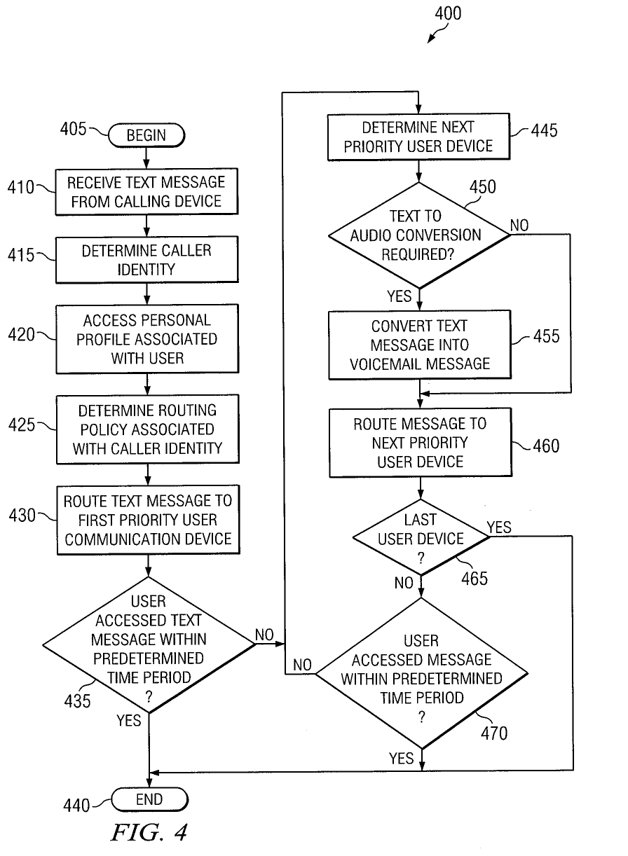

FIG. 4 is an embodiment of a procedure 400 for routing text messages to one or more user communication devices 105 associated with a user. In step 405, the procedure 400 begins. In steps 410, a text message from the calling device 175 addressed to the user is received by the message routing and conversion device 140. In step 415, a caller identity associated with the text message is determined. In at least one embodiment, the caller identity is determined from the phone number associated with the calling device 175 contained within the text message. In step 420, the user profile information contained in the personal profile associated with the user stored in the personal profile database 160 is accessed by the message routing and conversion device 140. In step 425, a routing policy associated with the caller identity is determined. In step 430, the text message is routed to the first priority user communication device 105. In an example embodiment, the first priority user communication device is the home mobile device 125.

In step 435, the message routing and conversion device 140 determining whether the user has accessed the text message using the first priority user communication device within a predetermined time period. If the user has accessed the text message using the first priority user communication device 105 within the predetermined time period, the procedure continues to step 440 in which the procedure 400 ends. If the user has not accessed the text message using the first priority user communication device 105 within the predetermined time period, the procedure continues to step 445. In step 445, the next priority user communication device 105 is determined. In step 450, it is determined whether text to audio conversion of the text message is required in order to route the message to the next priority user device 105. If text to audio conversion is not required, the procedure continues to step 460 in which the text message is routed to the next priority user device 105. If it is determined in step 450 that text to audio conversion is required, the procedure continues to step 455.

In step 455, the text message is converted into a voicemail message and the procedure continues to step 460 in which the voicemail message is routed to the next priority user device 105. The conversion of the text message into a voicemail message may be performed in accordance with one or more exiting text to voice conversion procedures The procedure then continues to step 465 in which it is determined whether the next priority user device 105 is the last user communication device 105 within the prioritization of user communication devices 105. If it is determined in step 465 that it is the last user communication device 105, the procedure continues to step 440 in which the procedure 400 ends. If it is determined in step 465 that it is not the last user communication device 105, the procedure continues to step 470. In step 470, it is determined whether the user has accessed the message within a predetermined time period using the next priority user communication device 105. If the user has accessed the message within the predetermined time period, the procedure continues to step 440 in which the procedure ends. If it is determined in step 470 that the user has not accessed the message within the predetermined time period, the procedure returns to step 445 in which the next priority user device is determined. In various embodiments, steps 445-460 are performed until the message has been sent to the last priority user communication device 105 or the user has accessed the message.

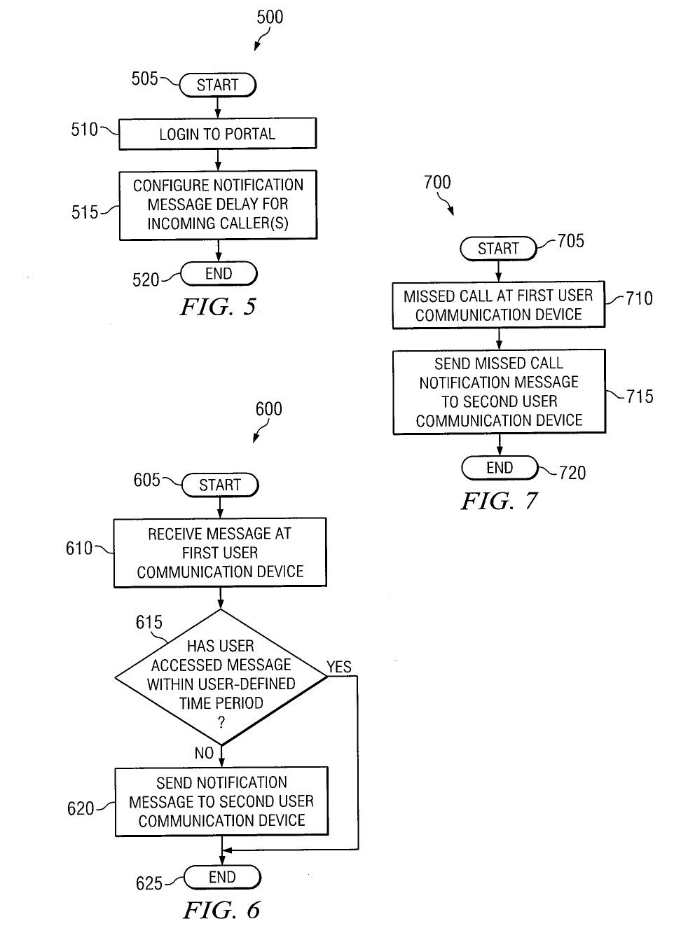

FIG. 5 is an embodiment of procedure 500 for configuring notification message delay for one or more user communication devices associated with a user. In accordance with at least one embodiment, the user may configure the personal profile to enable the sending of a notification message to a second one of the user communication devices 105 after a notification message delay time has elapsed after a caller has left a message, such as a voice message, a text message, or e-mail, at a first one of the user communication devices 105. In accordance with various embodiments, the notification message indicates to the user that the user has received a message from a particular caller at one of the user communication devices 105. The procedure 500 begins in step 505. In step 510, the user logs in to a portal to access the user's personal profile. In at least one embodiment, the user logs in to the portal by entering a user ID and/or password associated with the user. In at least one embodiment, the portal is a web portal. In step 515, the user configures notification message delay for one or more incoming callers. The notification message delay is a user-defined time period that will elapse after a message is left by a caller before the notification message is sent to the user. In accordance with various embodiments, the user may configure a different notification message delay for each incoming caller. Examples of user-defined time periods for notification message delay that may be configured by the user include 0 minutes, 5 minutes, 10 minutes, 15 minutes, thirty minutes, and sixty minutes. In various embodiments, the user can specify a different notification delay for each one of the user communication devices 105. In further embodiments, the user can configure which of the one or more user communication device 105 are to receive a notification message when a particular incoming caller leaves a message. In step 520, the procedure 500 ends.

FIG. 6 is a procedure 600 for sending a notification message indicating that message has been received at a user communication device after a user-defined time period has elapsed. The procedure 600 begins in step 605. In step 610, a message from an incoming caller using calling device 175 is received at a first user communication device of the user communication devices 105. The message is addressed to the user of a first user communication device. In various embodiments, the message may include, for example, a voicemail left at the first user communication device by the caller, a text message sent to the first user communication device by the caller, or an e-mail sent to the first user communication device by the caller. In step 615, the notification module 180 determines whether the user has accessed the message within a user-defined time period. In various embodiments, the user-defined time period is configured by the caller using the notification message delay configuration procedure 500 as described with respect to FIG. 5. In an alternative embodiment, the user-defined time period may be replaced by a caller-defined time period such that the caller leaving the message at the first user communication device may specify the notification message delay time period.

If it is determined in step 615 that the user has accessed the message within the user-defined time period, the procedure 600 continues to step 625. If it is determined in step 615 that the user has not accessed the message within the predetermined time period, the procedure 600 continues to step 620. In step 620, the notification module 180 sends a notification message to a second user communication device of the user communication devices 105. The notification message includes an indication that a message has been left by the incoming caller at the first user communication device, an identification of the incoming caller, and/or a time that the message was received at the first user communication device. In various embodiments, the notification message may include a voice message, a text message, and/or an e-mail. In step 625, the procedure 600 ends.

In an example operation of the embodiment of FIG. 6, a caller using calling device 175 leaves a voicemail message at the work communication device 115. After the user has not listened to the voicemail message after a user-defined time period has elapsed, in this example five minutes, a notification message is sent to the home mobile device 125. In the described example, the notification message is a text message. An example notification text message of the embodiment of FIG. 6 includes the following text: “Joe left a voicemail at work phone at 5:30 pm.”

FIG. 7 is an embodiment of a procedure 700 for sending a notification message of a missed call at a user communication device. The procedure 700 beings in step 705. In step 710, a missed call to a first user communication device of the user communication devices 105 occurs from an incoming caller using calling device 175. In one embodiment of FIG. 7, the missed call occurs because the user of the first user communication device 105 does not answer the call from the caller within a pre-determined time period or number of rings. In step 715, the notification module 180 sends a notification message to a second user communication device of the user communication devices 105. The notification message includes an indication that a call from incoming caller has been missed at the first user communication device, an identification of the incoming caller, and/or a time that the call was missed at the first user communication device. In various embodiments, the notification message can include a voice message, a text message, and/or an e-mail. In step 720, the procedure 700 ends.

In an example operation of the embodiment of FIG. 7, a caller using calling device 175 places a call to the work communication device 115. When the user misses the call because he does not pick up the receiver of the work communication device 115, a notification message is sent to the home mobile device 125. In the described example, the notification message is a text message. An example notification text message of the embodiments of FIG. 7 includes the following text: “You missed a call from Joe at work phone at 5:30 pm.”

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate or transport the program for use by or in connection with the instruction execution system, apparatus or device. In various embodiments, the message routing and conversion device 140 includes one or more processors operable to execute computer executable instructions from a computer-usable or computer-readable medium to perform the various capabilities of the message routing and conversion device 140 described herein.

The computer-usable or computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for message routing comprising:
receiving a message addressed to a user of a first user communication device;
determining whether the user has accessed the message within a predetermined time period; and
routing the message to a second user communication device associated with the user if the user has not accessed the message within the predetermined time period.

2. The method of claim 1, wherein the message comprises a voicemail message.

3. The method of claim 1, wherein the message comprises a text message.

4. The method of claim 1, further comprising:
converting the message from a first format into a second format before routing the message to the second user communication device.

5. The method of claim 4, wherein the converting includes converting a voicemail message into a text message.

6. The method of claim 4, wherein the converting includes converting a text message into a voicemail message.

7. The method of claim 1, further comprising:
determining a caller identity associated with the calling device;
determining a routing policy associated with the caller identity; and
determining the second user communication device from among a plurality of user communication devices based upon the routing policy.

8. The method of claim 7, wherein the routing policy includes time-of-day information associated with the user.

9. The method of claim 7, wherein the routing policy includes user location information.

10. The method of claim 7, wherein the routing policy includes prioritization information associated with a prioritization of the first user communication device and the second user communication device.

11. A method for message routing comprising:
receiving a message addressed to a user of a first user communication device;
determining whether the user has accessed the message within a user-defined time period; and
sending a notification message to a second user communication device associated with the user if the user has not accessed the message within the user-defined time period, the notification message indicating that a message has been left by a caller at the first user communication device.

12. The method of claim 11, wherein the notification message includes an identification of the caller.

13. The method of claim 11, wherein the notification message includes a time that the message was received at the first user communication device.

14. The method of claim 11, wherein the notification message includes a text message.

15. The method of claim 11, wherein the notification message includes a voice message.

16. A method for message routing comprising:
receiving a missed call at a first user communication device associated with a user; and
sending a notification message to a second user communication device associated with the user, the notification message indicating to the user that a call from a caller has been missed at the first user communication device.

17. The method of claim 16, wherein the notification message includes an identification of the caller.

18. The method of claim 16, wherein the notification message includes a time that the call was missed at the first user communication device.

19. The method of claim 16, wherein the notification message includes a text message.

20. The method of claim 11, wherein the notification message includes a voice message.
